(19) United States
(12) Patent Application Publication
(10) Pub. No.: US 2026/0277223 A1
(43) Pub. Date: Sep. 17, 2026

(54) FOOT STRUCTURE FOR ROBOT AND ROBOT

(71) Applicant: Sony Interactive Entertainment Inc., Tokyo (JP)

(72) Inventors: Kazuya Kikuchi, Tokyo (JP); Hiroshi Osawa, Tokyo (JP)

(73) Assignee: Sony Interactive Entertainment Inc., Tokyo (JP)

(21) Appl. No.: 19/669,439

(22) Filed: May 6, 2026

Related U.S. Application Data
(63) Continuation of application No. PCT/JP2024/038412, filed on Oct. 28, 2024.

(30) Foreign Application Priority Data
Nov. 7, 2023 (JP) 2023-190074

(51) Int. Cl. G05D 1/495; B62D 57/032; G01B 7/15; G05D 109/12

(52) U.S. Cl. CPC G05D 1/495; B62D 57/032; G01B 7/15; G05D 2109/12

(57) ABSTRACT

There are provided a foot structure for a robot and a robot that suffer small restrictions and are capable of detecting reactive forces from a walking surface with a simple structure. A foot includes an elastic member attached to a sole member and elastically supporting an instep member, a first range sensor disposed on one of the instep member and the sole member, for measuring the distance up to the other of the instep member and the sole member, and a second range sensor disposed on the one of the instep member and the sole member at a position different from the first range sensor, for measuring the distance up to the other of the instep member and the sole member.

### CROSS-REFERENCES TO RELATED APPLICATIONS

This application is a continuation of International Patent Application No. PCT/JP2024/038412, filed on Oct. 28, 2024, which claims priority to Japanese Patent Application No. 2023-190074, filed on Nov. 7, 2023, the entire disclosure of which is incorporated herein by reference for all purposes.

### TECHNICAL FIELD

The present disclosure relates to a foot structure for a robot and a robot.

### BACKGROUND

There have been developed in the art robots that include legs and that can walk by moving the legs. Such a robot includes sensors provided on its feet that contact a walking surface such as a floor surface or a ground surface, for detecting reactive forces from the walking surface, in some cases. With the sensors thus incorporated in the robot, it is possible to calculate the position of the center of gravity of the robot and control the robot in order to optimize the posture of the robot with respect to the walking surface.

For example, JP 2019-194418A discloses that a strain inducer that is flexurally deformable is disposed between an instep member coupled to a leg of a robot and a sole member for contacting a walking surface and a plurality of strain sensors are disposed on the strain inducer, to thereby detect reactive forces from the walking surface. For example, JP 2019-194417A referred to below discloses that an elastic body is supported at a fulcrum on one of an instep member and a sole member, for pressing a force sensor on the other thereof to detect reactive forces from a walking surface.

### SUMMARY

According to the structure of JP 2019-194418A referred to above, the strain inducer is in the form of a leaf spring supporting the instep member, and the plurality of strain sensors are directly mounted on the leaf spring. Since the strain sensors pose an upper limit on the magnitude of measurable strains, the structure of JP 2019-194418A suffers large structural restrictions. Further, according to the structure of JP 2019-194417A referred to above, inasmuch as the elastic body is provided separately from a leaf spring that supports the instep member, a foot structure includes many parts.

It is an object of the present disclosure to provide a foot structure for a robot and a robot that suffer reduced restrictions and are capable of detecting reactive forces from a walking surface with a simple structure.

A foot structure according to the present disclosure may be a foot structure provided on a lower end of a leg of a robot. The foot structure may include an instep member joined to the leg, a sole member disposed beneath the instep member, for contacting a walking surface, an elastic member attached to the sole member and elastically supporting the instep member, a first range sensor disposed on one of the instep member and the sole member, for measuring a distance up to the other of the instep member and the sole member, and a second range sensor disposed on the one of the instep member and the sole member at a position different from the first range sensor, for measuring a distance up to the other of the instep member and the sole member. This arrangement makes it possible to detect reactive forces from the walking surface with a simple structure of reduced restrictions.

A robot according to the present disclosure may be a robot having a leg and a foot structure provided on a lower end of the leg. The foot structure may include an instep member joined to the leg, a sole member disposed beneath the instep member, for contacting a walking surface, an elastic member attached to the sole member and elastically supporting the instep member, a first range sensor disposed on one of the instep member and the sole member, for measuring a distance up to the other of the instep member and the sole member, and a second range sensor disposed on the one of the instep member and the sole member at a position different from the first range sensor, for measuring a distance up to the other of the instep member and the sole member. This arrangement makes it possible to detect reactive forces from the walking surface with a simple structure of reduced restrictions.

### BRIEF DESCRIPTION OF DRAWINGS

FIG. 1 is a view illustrating a layout of actuators that a robot proposed by the present disclosure has.

FIG. 2A is a perspective view illustrating a foot of the robot.

FIG. 2B is a plan view illustrating the foot of the robot.

FIG. 3 is a cross-sectional view taken along line III-III of FIG. 2B.

FIG. 4 is a perspective view illustrating an upper side of a structure resulting from removing an instep member from the foot.

FIG. 5A is a perspective view illustrating a lower side of a structure resulting from removing a sole member from the foot.

FIG. 5B is a bottom view illustrating the lower side of the structure resulting from removing the sole member from the foot.

FIG. 6 is a diagram illustrating an example of electronic components mounted on a circuit board.

### DETAILED DESCRIPTION

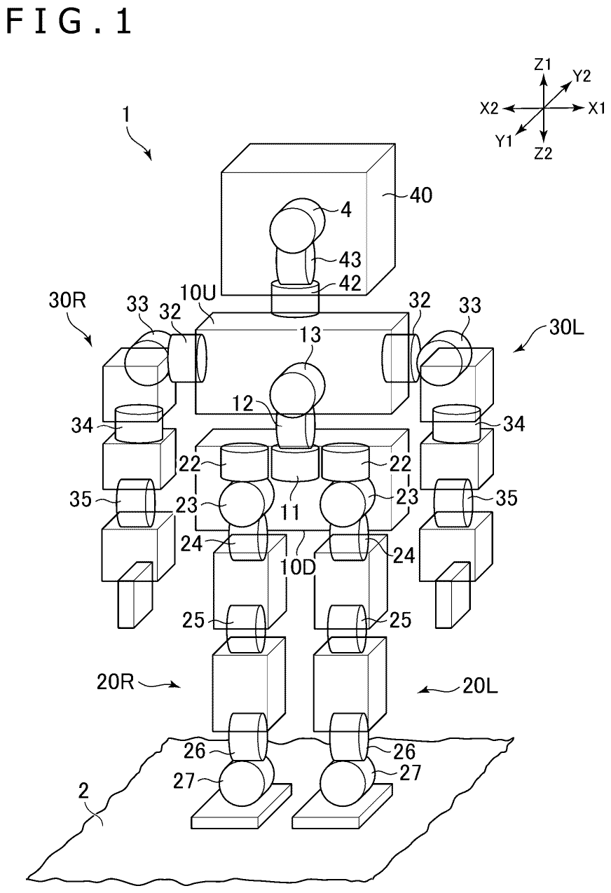

An embodiment of the present disclosure will hereinafter be described with reference to the drawings. FIG. 1 is a view illustrating a layout of actuators that a robot 1 proposed by the present disclosure has. In the description given below, an X1 direction and an X2 direction along an X-axis illustrated in FIG. 1 and other figures represent a leftward direction and a rightward direction, respectively. Further, a Y1 direction and a Y2 direction along a Y-axis that is illustrated in FIG. 1 and other figures and is perpendicular to the X-axis represent a forward direction and a rearward direction, respectively. Moreover, a Z1 direction and a Z2 direction along a Z-axis that is illustrated in FIG. 1 and other figures and is perpendicular to the X-axis and the Y-axis represent an upward direction and a downward direction, respectively. However, these directions and layout positions are defined to explain shapes and a relative positional relation of components (parts, members, and portions) of the robot 1 and not to limit postures and orientations of the robot 1.

The robot 1 represents a bipedal humanoid robot, for example. As illustrated in FIG. 1, the robot 1 may have a chest 10U, buttocks 10D, and actuators 11 through 13 corresponding to waist joints for moving the chest relatively to the buttocks 10D. The robot 1 may also have a right leg 20R, a left leg 20L, and a plurality of actuators for moving the legs 20R and 20L. Each of the legs 20R and 20L may have actuators 26 and 27 corresponding to ankle joints, an actuator 25 corresponding to a knee joint, and actuators 22 through 24 corresponding to hip joints. Moreover, the robot 1 may have a right arm 30R, a left arm 30L, and a plurality of actuators for moving the arms 30R and 30L. Each of the arms 30R and 30L may have an actuator 35 corresponding to an elbow joint, an actuator 34 disposed at an upper arm, and actuators 32 and 33 corresponding to shoulder joints. The robot 1 may further have a head 40 and a plurality of actuators 42 through 44 corresponding to neck joints for moving the head 40.

The three actuators 11 through 13 corresponding to the waist joints of the robot 1 may rotate about the Z-axis, the X-axis, and the Y-axis, respectively, to enable the chest 10U of the robot 1 to change its angles about three roll, pitch, and yaw axes relatively to the buttocks 10D. Further, the three actuators 42 through 44 corresponding to the neck joints of the robot 1 may rotate about the Z-axis, the X-axis, and the Y-axis, respectively, to also enable the head 40 of the robot 1 to change its angles about three roll, pitch, and yaw axes relatively to the chest 10U.

The actuators of the robot 1 are not limited to the layout illustrated in FIG. 1. For example, the robot 1 may have more actuators or less actuators than those illustrated in FIG. 1. In addition, the robot 1 may be free of the head 40, the chest 10U, and the arms 30R and 30L. Further, the robot 1 may not necessarily be a humanoid robot as illustrated in FIG. 1, and may be a quadrupedal robot shaped like an animal such as a dog or a cat. In this case, the robot 1 may have four legs including a front right leg, a front left leg, a rear right leg, and a rear left leg.

As illustrated in FIG. 1, each of the legs 20R and 20L of the robot 1 may have on its bottom a foot 100 (foot structure) for contacting a walking surface 2 such as a desktop or a floor surface. The foot 100 may be connected to the actuator 27 corresponding to the ankle joint of the leg 20R or 20L. The actuators 26 and 27 of each of the legs 20R and 20L may be rotatable about the X-axis and the Y-axis, respectively, to thereby change roll and pitch angles of the foot 100 of each of the legs 20R and 20L. Further, when the actuators 24 through 27 of each of the legs 20R and 20L move through appropriate angles, the robot 1 can walk on the walking surface 2.

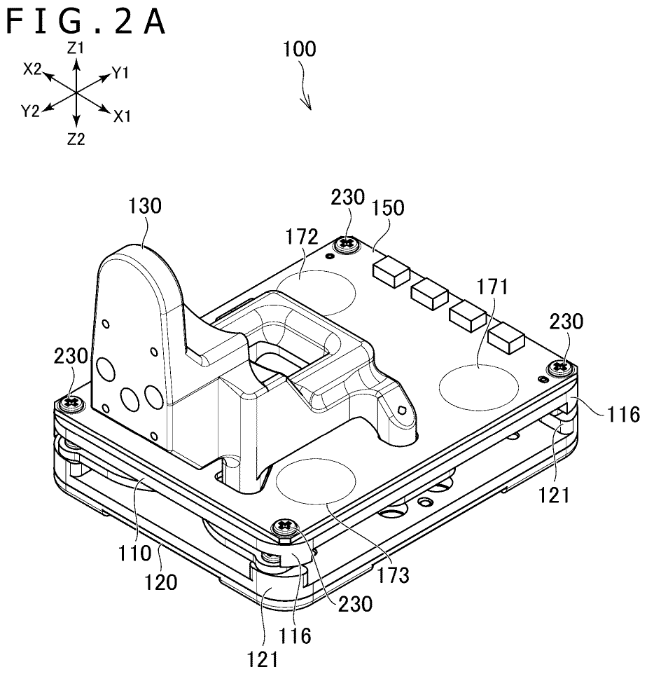

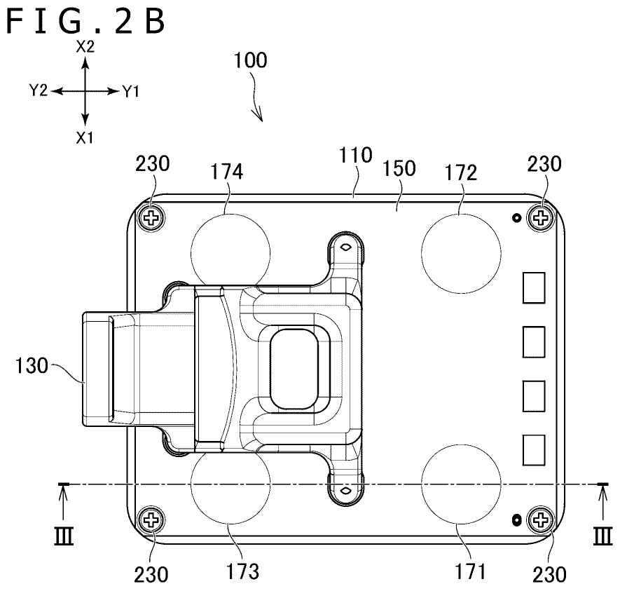

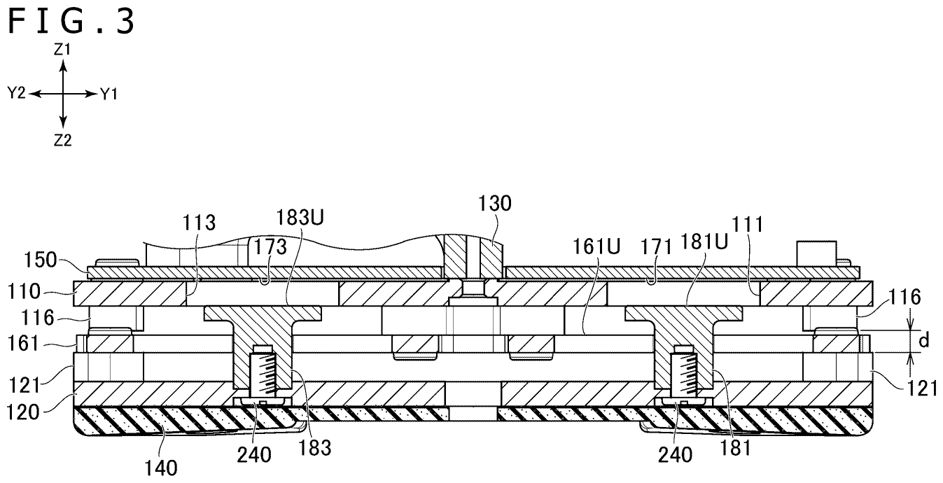

FIG. 2A illustrates in perspective the foot 100 of the robot 1. FIG. 2B illustrates in plan the foot 100 of the robot 1. FIG. 3 illustrates the foot in a cross section along line III-III of FIG. 2B.

As illustrated in FIG. 2A, the foot 100 may have an instep member 110 disposed in an upper portion of the foot 100 and a sole member 120 disposed in a bottom portion of the foot 100. The instep member 110 may have a joint 130 on its upper portion. The instep member 110 may be joined to the actuator 27 of the leg 20R or the leg 20L by the joint 130. However, the instep member 110 may directly be joined to the actuator 27 of the leg 20R or the leg 20L without a member such as the joint 130 interposed therebetween. The instep member 110 and the joint 130 may be made of a metal such as iron or aluminum or may be made of rubber, resin, or elastomer. The instep member 110 may be in the form of a plate made of any of these materials.

As illustrated in FIG. 2A, the sole member 120 may be disposed beneath the instep member 130. The sole member 120 may thus be brought into contact with the walking surface 2 (see FIG. 1). The sole member 120 may be made of a metal such as iron or aluminum or may be made of rubber, resin, or elastomer. The sole member 120 may be in the form of a plate made of any of these materials. As illustrated in FIG. 3, a skid-resistant member 140 made of rubber or elastomer may be disposed on a bottom portion of the sole member 120. The skid-resistant member 140 may be affixed to a bottom surface of the sole member 120 by an adhesive or the like.

As illustrated in FIG. 2B, the instep member 110 may be of a rectangular shape or a substantially rectangular shape. The instep member 110 may have two outer edges extending straight in the forward and rearward directions (along the Y-axis) at positions spaced from each other in the leftward and rightward directions (along the X-axis) and two edges extending straight in the leftward and rightward directions at positions spaced from each other in the forward and rearward directions. The instep member 110 may have four corners representing front left, front right, rear left, and rear right corners, respectively. Similarly, the sole member 120 may also be of a rectangular shape or a substantially rectangular shape and may have four outer edges extending straight in the forward and rearward directions and the leftward and rightward directions and four corners representing front left, front right, rear left, and rear right corners, respectively.

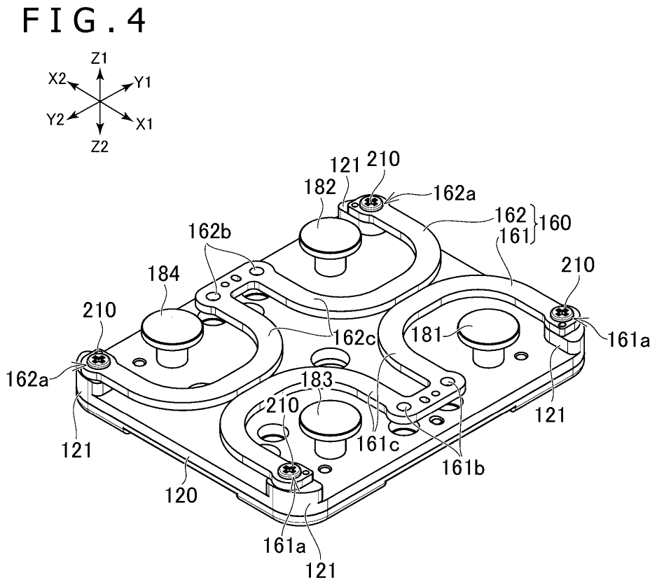

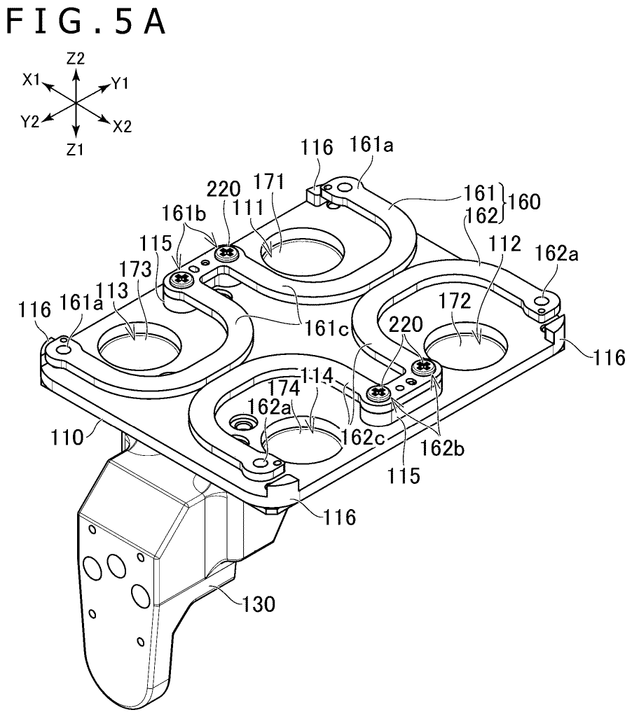

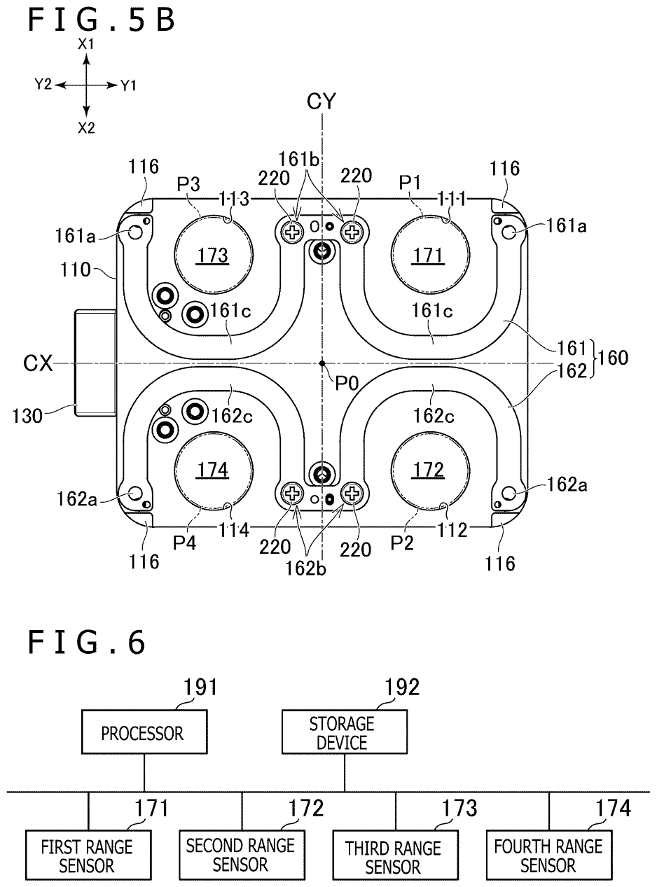

FIG. 4 illustrates in perspective an upper side of a structure resulting from removing the instep member 130 from the foot 100. FIG. 5A illustrates in perspective a lower side of a structure resulting from removing the sole member 120 from the foot 100. FIG. 5B illustrates in bottom view the lower side of the structure resulting from removing the sole member 120 from the foot 100.

As illustrated in FIG. 4, the foot 100 may have elastic members 160 attached to the sole member 120 by fasteners 210 such as screws. As illustrated in FIG. 5A, the elastic members 160 may be attached to the instep member 110 by fasteners 220 such as screws, to thereby elastically support the instep member 110.

As illustrated in FIGS. 2B and 5A, the foot 100 may have a first range sensor 171, a second range sensor 172, a third range sensor 173, and a fourth range sensor 174. In the description given below, the first through fourth range sensors 171 through 174 will also simply be referred to as range sensors. The four range sensors 171 through 174 may be disposed at positions different from each other on the instep member 110 and measure the distance up to the sole member 120, thereby making it possible to detect reactive forces acting on the sole member 120 from the walking surface 2 (see FIG. 1) and to calculate the position of the center of gravity of the robot 1.

As illustrated in FIG. 4, the sole member 120 may have a first detectable member 181, a second detectable member 182, a third detectable member 183, and a fourth detectable member 184. In the description given below, the first through fourth detectable members 181 through 184 will also simply be referred to as detectable members. The four detectable members 181 through 184 may be disposed at positions different from each other on the sole member 120. The detectable members 181 through 184 may be fixed to the sole member 120 by fasteners 240 (see FIG. 3) such as screws.

The detectable member 181 may be disposed at a first position P1, which is illustrated in FIG. 5B, corresponding to the range sensor 171. Stated otherwise, the detectable member 181 may be disposed at the same position as the range sensor 171 as viewed in plan. Similarly, the detectable member 182 may be disposed at a second position P2 corresponding to the range sensor 172. The detectable member 183 may be disposed at a third position P3 corresponding to the range sensor 173. The detectable member 184 may be disposed at a fourth position P4 corresponding to the range sensor 174. In the example illustrated in FIG. 5B, the first through fourth positions P1 through P4 represent positions within regions that do not overlap each other.

The range sensors 171 through 174 may measure the distances up to the respective detectable members 181 through 184 mounted on the sole member 120. The range sensors 171 through 174 may be non-contact sensors that are not in contact with the sole member 120 and the detectable members 181 through 184. The range sensors 171 through 174 in the form of non-contact sensors as described above are able to reduce structural restrictions on the foot 100 (e.g., restrictions on the hardness and shape of the elastic members 160) compared with strain sensors disposed on a strain inducer such as a leaf spring. In addition, the range sensors 171 through 174 in the form of non-contact sensors can reduce the number of parts used, compared with an arrangement in which elastic members different from the elastic members 160 supporting the instep member 110 press contact-type sensors, and is able to detect reactive forces from the walking surface 2 with a simpler structure.

For example, with an arrangement in which strain sensors are attached to a strain inducer, the strain sensors tend to have different performance levels depending on how they are bonded. In this regard, the range sensors 171 through 174 of the non-contact type can dispense with the step of bonding strain sensors and stabilize their measurement performance. Further, the range sensors 171 through 174 of the non-contact type are expected to have a longer service life as they avoid being physically contacted by other things.

Each of the range sensors 171 through 174 may be an eddy-current sensor, for example. In this case, each of the range sensors 171 through 174 may be formed as a coiled conductor pattern on a circuit board 150 that is to be supplied with a high-frequency current. Further, each of the detectable members 181 through 184 may be made of a conductive material such as aluminum. The range sensors 171 through 174 may calculate the distances up to the corresponding detectable members 181 through 184 on the basis of impedance changes depending on the distances.

As illustrated in FIG. 4, the elastic members 160 may include a first elastic member 161 and a second elastic member 162. As illustrated in FIG. 5B, the first elastic member 161 may be disposed in a position on the left side of a central line CX of the foot 100 in the leftward and rightward directions thereof. The second elastic member 162 may be disposed in a position on the right side of the central line CX of the foot 100. The first elastic member 161 and the second elastic member 162 may be shaped in bilateral symmetry.

As illustrated in FIGS. 4 and 5A, the first elastic member 161 may have lower attachments 161a (first lower attachments) attached to the sole member 120 by fasteners 210. Similarly, the second elastic member 162 may have lower attachments 162a (second lower attachments) attached to the sole member 120 by fasteners 210.

Further, as illustrated in FIGS. 5A and 5B, the first elastic member 161 may have upper attachments 161b (first upper attachments) attached to the instep member 110 at positions spaced from the lower attachments 161a along first directions (e.g., the forward and rearward directions). Similarly, the second elastic member 162 may have upper attachments 162b (second upper attachments) attached to the instep member 110 at positions spaced from the lower attachments 162a along second directions (e.g., the forward and rearward directions).

In the example illustrated in FIGS. 4, 5A, and 5B, the first directions and the second directions represent the forward and rearward directions. However, the first directions and the second directions may rather represent the leftward and rightward directions or oblique directions between the forward and rearward directions and the leftward and rightward directions. In the example illustrated in FIGS. 4, 5A, and 5B, the first directions are the same as the second directions. However, the first directions may rather represent directions different from the second directions. The first elastic member 161 may extend in a direction different from that of the second elastic member 162.

As illustrated in FIGS. 4 and 5A, the first elastic member 161 may have two lower attachments 161a attached to the sole member 120 and two upper attachments 161b attached to the instep member 110. As illustrated in FIG. 5B, the two upper attachments 161b and the two lower attachments 161a may be arrayed in the forward and rearward directions (the first directions). The two upper attachments 161b may be disposed between the two lower attachments 161a in the forward and rearward directions. The two lower attachments 161a may be disposed at positions closer to the ends of the sole member 120 than the two upper attachments 161b. Further, the first elastic member 161 may have portions integrally joined between the two upper attachments 161b.

Similarly, the second elastic member 162 may also have two lower attachments 162a attached to the sole member 120 and two upper attachments 162b attached to the instep member 120. The two upper attachments 162b and the two lower attachments 162a may be arrayed in the forward and rearward directions (the second directions). The two upper attachments 162b may be disposed between the two lower attachments 162a in the forward and rearward directions. The two lower attachments 162a may be disposed at positions closer to the ends of the sole member 120 than the two upper attachments 162b. Further, the second elastic member 162 may have portions integrally joined between the two upper attachments 162b.

As illustrated in FIG. 4, the instep member 110 may have supports 121 protruding upwardly form the corresponding four corners at respective front left, front right, rear left, and rear right portions and supporting the elastic member 160. The two lower attachments 161a of the first elastic member 161 may be attached to the support 121 provided on the front left corner of the instep member 110 and the support 121 provided on the rear left corner of the instep member 110. Similarly, the two lower attachments 162a of the second elastic member 162 may be attached to the support 121 provided on the front right corner of the instep member 110 and the support 121 provided on the rear right corner of the instep member 110.

As illustrated in FIG. 4, the first elastic member 161 may have curved portions 161c (first curved portions) curved and extending in a direction transverse to the forward and rearward directions (the first directions) and connected to the lower attachments 161a and the upper attachments 161b. Similarly, the second elastic member 162 may have curved portions 162c (second curved portions) curved and extending in a direction transverse to the forward and rearward directions (the second directions) and connected to the lower attachments 162a and the upper attachments 162b.

As illustrated in FIG. 5B, the first position P1 where the range sensor 171 and the detectable member 181 are disposed may be located between the lower attachment 161a and the upper attachment 161b that are next to each other on a front side of the first elastic member 161 (on one side thereof in the first directions). Similarly, the third position P3 where the range sensor 173 and the detectable member 183 are disposed may be located between the lower attachment 161a and the upper attachment 161b that are next to each other on a rear side of the first elastic member 161 (on the other side thereof in the first directions).

Further, the second position P2 where the range sensor 172 and the detectable member 182 are disposed may be located between the lower attachment 162a and the upper attachment 162b that are next to each other on a front side of the second elastic member 162 (on one side thereof in the second directions). Similarly, the fourth position P4 where the range sensor 174 and the detectable member 184 are disposed may be located between the lower attachment 162a and the upper attachment 162b that are next to each other on a rear side of the second elastic member 162 (on the other side thereof in the first directions).

As illustrated in FIGS. 4 and 5A, the curved portion 161c disposed on the front side of the first elastic member 161 may extend clear of the range sensor 171 and the detectable member 181. Similarly, the curved portion 161c disposed on the rear side of the first elastic member 161 may extend clear of the range sensor 173 and the detectable member 183. Further, the curved portion 162c disposed on the front side of the second elastic member 162 may extend clear of the range sensor 172 and the detectable member 182. Similarly, the curved portion 162c disposed on the rear side of the second elastic member 162 may extend clear of the range sensor 174 and the detectable member 184.

By thus forming the curved portions 161c in the first elastic member 161 and forming the curved portions 162c in the second elastic member 162, the lengths of the elastic members 161 and 162 in the leftward and rightward directions and the forward and rearward directions are secured, making elastic members 161 and 162 elastically flexible. Further, the elastic members 161 and 162 extend clear of the range sensors 171 through 174 and the detectable members 181 through 184. Therefore, the elastic members 161 and 162 are restrained from affecting the manner in which the range sensors 171 through 174 detect distances.

As illustrated in FIG. 4, each of the detectable members 181 through 184 may have a circular upper surface. As illustrated in FIG. 3, an upper surface 181U of the detectable member 181 and an upper surface 183U of the detectable member 183 may be disposed above an upper surface 161U of the first elastic member 161. Similarly, upper surfaces of the detectable members 182 and 184 may also be disposed above an upper surface of the second elastic member 162. With this arrangement, the distances from the range sensors 171 through 174 to the detectable members 181 through 184 may be smaller than the distances up to the elastic members 161 and 162. Therefore, the elastic members 161 and 162 are restrained from affecting the manner in which the range sensors 171 through 174 detect distances.

In the example illustrated in FIG. 5B, the first position P1 where the range sensor 171 and the detectable member 181 are disposed is spaced from the second position P2 where the range sensor 172 and the detectable member 182 are disposed, in the leftward and rightward directions (directions transverse to the first directions and the second directions). Here, the curved portion 161c disposed on the front side of the first elastic member 161 (on one side thereof in the first directions) and the curved portion 162c disposed on the front side of the second elastic member 162 (on one side thereof in the second directions) may pass between the first position P1 and the second position P2. Moreover, the third position P3 where the range sensor 173 and the detectable member 183 are disposed and the fourth position P4 where the range sensor 174 and the detectable member 184 are disposed may also be spaced from each other in the leftward and rightward directions. Further, the curved portion 161c disposed on the rear side of the first elastic member 161 (on the other side thereof in the first directions) and the curved portion 162c disposed on the rear side of the second elastic member 162 (on the other side thereof in the second directions) may also pass between the third position P3 and the fourth position P4. With the curved portions 161c and 162c of the elastic members 161 and 162 being thus disposed, the lengths of the elastic members 161 and 162 can be secured without enlarging the foot 100 in the leftward and rightward directions.

As illustrated in FIG. 5B, the first position P1 where the range sensor 171 and the detectable member 181 are disposed may be located forwardly and leftwardly of a central position P0 of the foot 100 (the point of intersection between the central line CX of the foot 100 in the leftward and rightward directions and a central line CY of the foot 100 in the forward and rearward directions). In addition, the second position P2 where the range sensor 172 and the detectable member 182 are disposed may be located forwardly and rightwardly of the central position P0 of the foot 100. Moreover, the third position P3 where the range sensor 173 and the detectable member 183 are disposed may be located rearwardly and leftwardly of the central position P0 of the foot 100. Further, the fourth position P4 where the range sensor 174 and the detectable member 184 are disposed may be located rearwardly and rightwardly of the central position P0 of the foot 100.

The range sensors 171 through 174 are thus disposed to measure reactive forces from the walking surface 2 at the front left position P1, the front right position P2, the rear left position P3, and the rear right position P4 on the foot 100, so that it is possible to determine where the reactive forces are large among the front left, front right, rear left, and rear right portions of the foot 100 and where the reactive forces are biased among various portions of the foot 100. Further, each of the four range sensors 171 through 174 may be disposed at a vertex of a rectangle (e.g., an oblong having longer sides extending in the forward and rearward directions). This makes it easy for a processor 191 (see FIG. 6) to be described later to calculate the position of the center of gravity of the foot 100.

As illustrated in FIG. 2A, the foot 100 may have the circuit board 150. The four range sensors 171 through 174 may be mounted on the circuit board 150. The circuit board 150 may be disposed on the instep member 110. With the circuit board 150 disposed on the instep member 110 instead of the sole member 120, impacts that occur on the instep member 110 when the robot 1 walks on the walking surface 2 can be prevented from being applied to the circuit board 150 and the range sensors 171 through 174. The circuit board 150 may be fixed to the upper surface of the instep member 110 by fasteners 230 such as screws.

FIG. 6 is a diagram illustrating an example of electronic components mounted on the robot 1. As illustrated in FIG. 6, the robot 1 may have the processor 191 and a storage device 192 as well as the range sensors 171 through 174 mounted on the circuit board 150. The processor 191 refers to an electronic component for performing data processing and may be a central processing unit (CPU), for example. The storage device 192 refers to a memory device such as a read only memory (ROM) or a random access memory (RAM). The storage device 192 may store programs to be executed by the processor 191 and data such as computational formulas. The processor 191 and the storage device 192 may be mounted on the circuit board 150 of the foot 100 or a circuit board provided in a portion of the robot 1 that is different from the foot 100.

The processor 191 may calculate the position of the center of gravity of the foot 100 on the basis of respective detected results from the four range sensors 171 through 174. The processor 191 or another processor (e.g., a processor disposed in a position in the robot 1 that is different from the foot 100) is thus able to determine the state of the walking surface 2 and to control the actuators 11 through 13, 26, 27, 32 through 35, and 42 through 44 for optimizing the posture of the robot 1 with respect to the walking surface 2.

As illustrated in FIGS. 3 and 5A, the instep member 110 may have four through areas 111 through 114 that are represented by holes defined therethrough in the upward and downward directions. The four through areas 111 through 114 may be defined in positions that are different from each other in the instep member 110. Note that at least one of the through areas 111 through 114 may not be a hole but a recess defined in an edge of the instep member 110.

The four range sensors 171 through 174 may be disposed respectively in the four through areas 111 through 114. As viewed in plan, the range sensor 171 may be disposed within the first through area 111, the range sensor 172 within the second through area 112, the range sensor 173 within the third through area 113, and the range sensor 174 within the fourth through area 114. With the range sensors 171 through 174 thus disposed in position, the instep member 110 can be prevented from affecting the manner in which the range sensors 171 through 174 detect distances.

The four detectable members 181 through 184 may also be disposed respectively in the four through areas 111 through 114. As illustrated in FIG. 3, the first through area 111 may expose the upper surface 181U of the detectable member 181 in its entirety, and the third through area 113 may expose the upper surface 183U of the detectable member 183 in its entirety. Similarly, the second through area 112 may expose the upper surface of the detectable member 182 in its entirety, and the fourth through area 114 may expose the upper surface of the detectable member 184 in its entirety. Stated otherwise, as viewed in plan, the detectable member 181 may be disposed within the first through area 111, the detectable member 182 may be disposed within the second through area 112, the detectable member 183 may be disposed within the third through area 113, and the detectable member 184 may be disposed within the fourth through area 114. With this arrangement, the distances from the range sensors 171 through 174 to the detectable members 181 through 184 may be reduced. Therefore, even if the range of distances that can be measured by the range sensors 171 through 174 is small, the accuracy of the distances detected by the range sensors 171 through 174 can be increased. Moreover, the detectable members 181 through 184 can be prevented from interfering with the instep member 110.

As illustrated in FIG. 5B, the curved portion 161c that is disposed on the front side of the first elastic member 161 (on one side thereof in the first directions) may extend clear of the first through area 111. Similarly, the curved portion 161c that is disposed on the rear side of the first elastic member 161 (on the other side thereof in the first directions) may extend clear of the third through area 113. Further, the curved portion 162c that is disposed on the front side of the second elastic member 162 (on one side thereof in the second directions) may extend clear of the second through area 112. Similarly, the curved portion 162c that is disposed on the rear side of the second elastic member 162 (on the other side thereof in the second directions) may extend clear of the fourth through area 114. With this arrangement, the elastic members 161 and 162 are restrained more reliably from affecting the manner in which the range sensors 171 through 174 detect distances.

As illustrated in FIG. 5B, each of the through areas 111 through 114 may have a circular outer peripheral edge. The curved portions 161c of the first elastic member 161 may be curved arcuately along the outer peripheral edges of the through area 111 and the through area 113. Similarly, the curved portions 162c of the second elastic member 162 may be curved arcuately along the outer peripheral edges of the through area 112 and the through area 114.

As illustrated in FIG. 5A, the instep member 110 may have two attachment lands 115 which protrude downwardly and to which the upper attachments 161b and 162b of the elastic members 161 and 162 are attached. One of the two attachment lands 115 may be disposed in a position on the left side of the central line CX (see FIG. 5B) of the foot 100 in the leftward and rightward directions thereof, while the other may be disposed in a position on the right side of the central line CX. Further, the two attachment lands 115 may be disposed on the central line CY (see FIG. 5B) of the foot 100 in the forward and rearward directions.

As illustrated in FIG. 5A, the instep member 110 may have four protrusions 116 that protrude downwardly (in the Z2 direction in FIG. 5A) from corresponding four corners representing front left, front right, rear left, and rear right corners, respectively, thereof. The protrusions 116 may be provided in positions clear of the elastic members 160. As illustrated in FIG. 3, the protrusions 116 may have respective lower surfaces that face the upper surfaces of the supports 121 of the sole member 120 with a gap d left therebetween. When the sole member 120 is tilted with respect to the instep member 110, either one of the four protrusions 116 may be brought into contact with the corresponding support 121, thereby making it possible to prevent the sole member 120 from being tilted excessively with respect to the instep member 110.

Note that the present disclosure is not limited to the embodiment described above. According to the embodiment, for example, it has been described by way of example that the sole member 120 has the four detectable members 181 through 184 and that the four range sensors 171 through 174 disposed on the instep member 110 measure the respective distances up to the four detectable members 181 through 184. However, the sole member 120 may not necessarily have the detectable members 181 through 184. In this case, the range sensors 171 through 174 disposed on the instep member 110 may directly measure the distances up to the upper surface of the sole member 120.

According to the embodiment, moreover, it has been described by way of example that the four range sensors 171 through 174 disposed on the instep member 110 measure the respective distances up to the four detectable members 181 through 184 attached to the sole member 120. However, the four range sensors 171 through 174 may be disposed on the sole member 120. In this case, the range sensors 171 through 174 may measure the distances up to the instep member 110.

Specifically, the four range sensors 171 through 174 may be disposed on one of the instep member 110 and the sole member 120 and measure the distances up to the other member. In this case, the four detectable members 181 through 184 may be attached to the other member (e.g., the instep member 110), and the range sensors 171 through 174 may measure the distances up to the detectable members 181 through 184. In this manner, reactive forces acting on the sole member 120 from the walking surface 2 can also be detected. Further, the range sensors 171 through 174 that are in the form of non-contact sensors are able to reduce structural restrictions on the foot 100 and to detect reactive forces from the walking surface 2 with a simple structure.

According to the embodiment, moreover, it has been described by way of example that the first elastic member 161 has portions integrally joined between the two upper attachments 161b and that the second elastic member 162 has portions integrally joined between the two upper attachments 162b. However, the first elastic member 161 may be severed between the two upper attachments 161b, and the second elastic member 162 may also be severed between the two upper attachments 162b. In this case, the number of elastic members included in the foot 100 may be three or four.

In addition, the number of range sensors (and detectable members) provided on the foot 100 may not be four, and may be two or three, or five or more. For example, the foot 100 may have two range sensors, and one of the range sensors may be disposed in a position on the left side of the central line CX (see FIG. 5B) of the foot 100 in the leftward and rightward directions thereof whereas the other range sensor may be disposed in a position on the right side of the central line CX, thereby determining which of the right side and the left side of the sole member 120 is receiving larger reactive forces. Further, for example, one of the range sensors may be disposed in a position on the front side of the central line CY (see FIG. 5B) of the foot 100 in the forward and rearward directions thereof whereas the other range sensor may be disposed in a position on the rear side of the central line CY, thereby determining which of the front side and the rear side of the sole member 120 is receiving larger reactive forces.
(1)

As described above, the foot structure described in the disclosure may be a foot structure provided on a lower end of a leg of a robot. The foot structure may include an instep member joined to the leg, a sole member disposed beneath the instep member, for contacting a walking surface, an elastic member attached to the sole member and elastically supporting the instep member, a first range sensor disposed on one of the instep member and the sole member, for measuring a distance up to the other of the instep member and the sole member, and a second range sensor disposed on the one of the instep member and the sole member at a position different from the first range sensor, for measuring a distance up to the other of the instep member and the sole member. This arrangement makes it possible to detect reactive forces from the walking surface with a simple structure of reduced restrictions.
(2)

In the foot structure according to (1) described above, the other of the instep member and the sole member may have a first detectable member disposed at a first position corresponding to the first range sensor and a second detectable member disposed at a second position corresponding to the second range sensor. The first range sensor may detect a distance up to the first detectable member. The second range sensor may detect a distance up to the second detectable member.
(3)

In the foot structure according to (2) described above, the elastic member may have a lower attachment attached to the sole member, an upper attachment attached to the instep member at a position spaced from the lower attachment along a first direction, and a curved portion curved and extending in a direction transverse to the first direction and connected to the lower attachment and the upper attachment. The first range sensor and the first detectable member may be disposed between the lower attachment and the upper attachment. The curved portion may extend clear of the first range sensor and the first detectable member.
(4)

In the foot structure according to (2) described above, the elastic member may include a first elastic member and a second elastic member. The first elastic member may have a first lower attachment attached to the sole member, a first upper attachment attached to the instep member at a position spaced from the first lower attachment along a first direction, and a first curved portion curved and extending in a direction transverse to the first direction and connected to the first lower attachment and the first upper attachment. The second elastic member may have a second lower attachment attached to the sole member, a second upper attachment attached to the instep member at a position spaced from the second lower attachment along a second direction, and a second curved portion curved and extending in a direction transverse to the second direction and connected to the second lower attachment and the second upper attachment. The first range sensor and the first detectable member may be disposed between the first lower attachment and the first upper attachment. The second range sensor and the second detectable member may be disposed between the second lower attachment and the second upper attachment. The first curved portion may extend clear of the first range sensor and the first detectable member. The second curved portion may extend clear of the second range sensor and the second detectable member.
(5)

In the foot structure according to (4) described above, the second direction may be the same as the first direction. The first position where the first range sensor and the first detectable member are disposed may be spaced from the second position where the second range sensor and the second detectable member are disposed, in a direction transverse to the first direction. The first curved portion and the second curved portion may pass between the first position and the second position.
(6)

In the foot structure according to any one of (2) through (5) described above, a third range sensor and a fourth range sensor may be disposed on the one of the instep member and the sole member. A third detectable member disposed at a third position corresponding to the third range sensor and a fourth detectable member disposed at a fourth position corresponding to the fourth range sensor may be disposed on the other of the instep member and the sole member.
(7)

In the foot structure according to (6) described above, the first position where the first range sensor and the first detectable member are disposed may be located forwardly and leftwardly of a central position of the foot structure and the second position where the second range sensor and the second detectable member are disposed may be located forwardly and rightwardly of the central position of the foot structure. The third position where the third range sensor and the third detectable member are disposed may be located rearwardly and leftwardly of the central position of the foot structure. The fourth position where the fourth range sensor and the fourth detectable member are disposed may be located rearwardly and rightwardly of the central position of the foot structure.
(8)

The foot structure according to (7) described above may further include a processor for calculating a position of a center of gravity of the foot structure on the basis of respective detected results from the first range sensor, the second range sensor, the third range sensor, and the fourth range sensor.
(9)

In the foot structure according to any one of (3) through (8) described above, the lower attachments (the first lower attachment and the second lower attachment) may be disposed at positions closer to ends of the sole member than the upper attachments (the first upper attachment and the second upper attachment).
(10)

In the foot structure according to any one of (1) through (9) described above, the first range sensor and the second range sensor may be disposed on the instep member and measure distances up to the sole member.
(11)

The foot structure according to (10) described above may further include a circuit board on which the first range sensor and the second range sensor are mounted and that is disposed on the instep member. The instep member may have a first through area including a hole or a recess that is defined therethrough in upward and downward directions and a second through area including a hole or a recess that is defined therethrough in upward and downward directions at a position different from the first through area. The first range sensor may be disposed in the first through area. The second range sensor may be disposed in the second through area.
(12)

In the foot structure according to (11) described above, the elastic member may include a first elastic member and a second elastic member. The first elastic member may have a first lower attachment attached to the sole member, a first upper attachment attached to the instep member at a position spaced from the first lower attachment along a first direction, and a first curved portion curved and extending in a direction transverse to the first direction and connected to the first lower attachment and the first upper attachment. The second elastic member may have a second lower attachment attached to the sole member, a second upper attachment attached to the instep member at a position spaced from the second lower attachment along a second direction, and a second curved portion curved and extending in a direction transverse to the second direction and connected to the second lower attachment and the second upper attachment. The first curved portion may extend along an edge of the first through area and clear of the first through area. The second curved portion may extend along an edge of the second through area and clear of the second through area.
(13)

In the foot structure according to any one of (1) through (9) described above, the first range sensor and the second range sensor may each be an eddy-current sensor.
(14)

Further, the robot described in the present disclosure may be a robot having a leg and a foot structure provided on a lower end of the leg. The foot structure may include an instep member joined to the leg, a sole member disposed beneath the instep member, for contacting a walking surface, an elastic member attached to the sole member and elastically supporting the instep member, a first range sensor disposed on one of the instep member and the sole member, for measuring a distance up to the other of the instep member and the sole member, and a second range sensor disposed on the one of the instep member and the sole member at a position different from the first range sensor, for measuring a distance up to the other of the instep member and the sole member. This arrangement makes it possible to detect reactive forces from the walking surface with a simple structure of reduced restrictions.

What is claimed is:

1. A foot structure provided on a lower end of a leg of a robot, the foot structure comprising:
an instep member joined to the leg;
a sole member disposed beneath the instep member, and configured to contact a walking surface;
an elastic member attached to the sole member and elastically supporting the instep member;
a first range sensor disposed on one of the instep member or the sole member, the first range sensor configured to measure a distance to the other of the instep member or the sole member; and
a second range sensor disposed on the one of the instep member or the sole member at a position different from the first range sensor, the second range sensor configured to measure a distance to the other of the instep member or the sole member.

2. The foot structure according to claim 1, wherein
the other of the instep member or the sole member includes a first detectable member disposed at a first position corresponding to the first range sensor and a second detectable member disposed at a second position corresponding to the second range sensor,
the first range sensor is configured to detect a distance to the first detectable member, and
the second range sensor is configured to detect a distance to the second detectable member.

3. The foot structure according to claim 2, wherein
the elastic member includes a lower attachment attached to the sole member, an upper attachment attached to the instep member at a position spaced from the lower attachment along a first direction, and a curved portion curved and extending in a direction transverse to the first direction and connected to the lower attachment and the upper attachment,
the first range sensor and the first detectable member are disposed between the lower attachment and the upper attachment, and
the curved portion is disposed clear of the first range sensor and the first detectable member.

4. The foot structure according to claim 3, wherein
the lower attachment is disposed at a position closer to an end of the sole member than the upper attachment.

5. The foot structure according to claim 2, wherein
the elastic member includes a first elastic member and a second elastic member,
the first elastic member includes a first lower attachment attached to the sole member, a first upper attachment attached to the instep member at a position spaced from the first lower attachment along a first direction, and a first curved portion curved and extending in a direction transverse to the first direction and connected to the first lower attachment and the first upper attachment,
the second elastic member includes a second lower attachment attached to the sole member, a second upper attachment attached to the instep member at a position spaced from the second lower attachment along a second direction, and a second curved portion curved and extending in a direction transverse to the second direction and connected to the second lower attachment and the second upper attachment,
the first range sensor and the first detectable member are disposed between the first lower attachment and the first upper attachment,
the second range sensor and the second detectable member are disposed between the second lower attachment and the second upper attachment,
the first curved portion is disposed clear of the first range sensor and the first detectable member, and
the second curved portion is disposed clear of the second range sensor and the second detectable member.

6. The foot structure according to claim 5, wherein
the second direction is same as the first direction,
the first position where the first range sensor and the first detectable member are disposed is separate from the second position where the second range sensor and the second detectable member are disposed, in a direction transverse to the first direction, and
the first curved portion and the second curved portion are disposed between the first position and the second position.

7. The foot structure according to claim 2, wherein
a third range sensor and a fourth range sensor are disposed on the one of the instep member or the sole member, and
a third detectable member disposed at a third position corresponding to the third range sensor and a fourth detectable member disposed at a fourth position corresponding to the fourth range sensor are disposed on the other of the instep member or the sole member.

8. The foot structure according to claim 7, wherein
the first position where the first range sensor and the first detectable member are disposed is located forwardly and leftwardly of a central position of the foot structure,
the second position where the second range sensor and the second detectable member are disposed is located forwardly and rightwardly of the central position of the foot structure,
the third position where the third range sensor and the third detectable member are disposed is located rearwardly and leftwardly of the central position of the foot structure, and
the fourth position where the fourth range sensor and the fourth detectable member are disposed is located rearwardly and rightwardly of the central position of the foot structure.

9. The foot structure according to claim 8, further comprising:
a processor for calculating a position of a center of gravity of the foot structure based on respective detected results from the first range sensor, the second range sensor, the third range sensor, and the fourth range sensor.

10. The foot structure according to claim 1, wherein
the first range sensor and the second range sensor disposed on the instep member and are configured to measure distances to the sole member, respectively.

11. The foot structure according to claim 10, further comprising:
a circuit board disposed on the instep member, wherein the first range sensor and the second range sensor are mounted on the circuit board, and wherein
the instep member includes a first through area including a hole or a recess that is defined therethrough in upward and downward directions and a second through area including a hole or a recess that is defined therethrough in upward and downward directions at a position different from the first through area,
the first range sensor is disposed in the first through area, and
the second range sensor is disposed in the second through area.

12. The foot structure according to claim 11, wherein
the elastic member includes a first elastic member and a second elastic member,
the first elastic member includes a first lower attachment attached to the sole member, a first upper attachment attached to the instep member at a position separate from the first lower attachment along a first direction, and a first curved portion curved and extending in a direction transverse to the first direction and connected to the first lower attachment and the first upper attachment,
the second elastic member includes a second lower attachment attached to the sole member, a second upper attachment attached to the instep member at a position separate from the second lower attachment along a second direction, and a second curved portion curved and extending in a direction transverse to the second direction and connected to the second lower attachment and the second upper attachment,
the first curved portion extends along an edge of the first through area and clear of the first through area, and
the second curved portion extends along an edge of the second through area and clear of the second through area.

13. The foot structure according to claim 1, wherein
the first range sensor and the second range sensor are each an eddy-current sensor.

14. The foot structure according to claim 1, wherein the sole member includes a skid-resistant member comprising rubber or elastomer disposed on a bottom surface of the sole member.

15. The foot structure according to claim 1, wherein the instep member includes a protrusion extending toward the sole member, the protrusion configured to limit tilting of the sole member relative to the instep member by contacting the sole member when the sole member is tilted beyond a predetermined gap.

16. The foot structure according to claim 1, wherein the first range sensor and the second range sensor are each an eddy-current sensor comprising a coiled conductor pattern on a circuit board.

17. The foot structure according to claim 1, further comprising a processor configured to calculate a position of a center of gravity of the foot structure based on detected results from at least the first range sensor and the second range sensor.

18. A robot comprising:
a leg; and
a foot structure provided on a lower end of the leg, the foot structure including:
an instep member joined to the leg;
a sole member disposed beneath the instep member, the first range sensor configured to contact a walking surface;
an elastic member attached to the sole member and elastically supporting the instep member;
a first range sensor disposed on one of the instep member or the sole member, and configured to measure a distance to the other of the instep member or the sole member; and
a second range sensor disposed on the one of the instep member or the sole member at a position different from the first range sensor, the second range sensor configured to measure a distance to the other of the instep member or the sole member.

19. The robot according to claim 18, wherein the robot is a bipedal humanoid robot further comprising a chest and a plurality of actuators corresponding to waist joints configured to move the chest relatively to a buttocks portion.

20. The robot according to claim 18, wherein the leg includes an ankle joint actuator configured to rotate the foot structure about a roll axis and a pitch axis.
